(19) United States
(12) Patent Application Publication
(10) Pub. No.: US 2023/0400681 A1
(43) Pub. Date: Dec. 14, 2023

(54) SYSTEMS AND METHODS FOR WASHING HEAD-MOUNTED DEVICES

(71) Applicant: Universal City Studios LLC, Universal City, CA (US)

(72) Inventors: Patrick John Goergen, Orlando, FL (US); Martin Evan Graham, Clermont, FL (US)

(21) Appl. No.: 18/318,549

(22) Filed: May 16, 2023

Related U.S. Application Data
(60) Provisional application No. 63/350,723, filed on Jun. 9, 2022.

(51) Int. Cl. G02B 27/00; G02B 27/01; G06K 7/10; G06K 19/07

(52) U.S. Cl. CPC G02B 27/0006; G02B 27/017; G06K 7/10297; G06K 19/0723

(57) ABSTRACT

A system for washing components of head-mounted devices may include a reader to read identification information from a plurality of interface devices that are used in conjunction with or that are components of head-mounted devices. Each interface device may include an RFID tag including respective identification information of the interface device. The system may also include a washing system. Further, the system may include a controller with a processor and a memory, wherein the control may receive the identification information from the reader or wash cycle information from the washing system to determine whether the interface device has reached a threshold level of degradation.

### CROSS-REFERENCE TO RELATED APPLICATIONS

The present application claims priority to and the benefit of U.S. Provisional Application No. 63/350,723, entitled “SYSTEMS AND METHODS FOR WASHING HEAD-MOUNTED DEVICES”, and filed on Jun. 9, 2022, the disclosure of which is incorporated by reference in its entirety.

### FIELD OF DISCLOSURE

The subject matter disclosed herein relates generally to the field of virtual reality and/or augmented reality. More specifically, embodiments of the present disclosure relate to systems and methods utilized to clean user-contacting components of a head-mounted device (HMD).

This section is intended to introduce the reader to various aspects of art that may be related to various aspects of the present disclosure, which are described and/or claimed below. This discussion is believed to help provide the reader with background information to facilitate a better understanding of the various aspects of the present disclosure. Accordingly, it is understood that these statements are to be read in this light, and not as admissions of prior art.

Various amusement rides have been created to provide passengers with unique motion and visual experiences. For example, virtual reality and/or augmented reality (VR/AR) systems may be used in conjunction with amusement park rides and can be implemented with multi-passenger vehicles that travel along a fixed path. Headwear such as an HMD may include a display and may be implemented to give the wearer a VR/AR experience in a given ride. Because HMDs come into close contact with users, there exists a need to wash the HMDs with regularity.

### BRIEF DESCRIPTION

Certain embodiments commensurate in scope with the originally claimed subject matter are summarized below. These embodiments are not intended to limit the scope of the claimed subject matter, but rather these embodiments are intended only to provide a brief summary of possible forms of the subject matter. Indeed, the subject matter may encompass a variety of forms that may be similar to or different from the embodiments set forth below.

In an embodiment, a system may include a reader to read identification information from an interface device of a number of interface devices. The interface device may include a radio frequency identification (RFID) tag storing the identification information of the interface device. Further, the system may include a washing system and a controller. The controller may include a processor and a memory, and may receive the identification information from the reader or wash cycle information of the interface device from the washing system to determine whether the interface device has reached a threshold level of degradation.

In an embodiment, a system may include an interface device to reversibly mate with a display. The interface device may include a radio frequency identification (RFID) tag associated with the interface device storing identification information of the interface device. The system may also include a reader to read the identification from the RFID tag, a washing system, and a controller including a processor and memory. The controller may receive the identification information form the reader and wash cycle information from the washing system. Further, the controller may associate the wash cycle information with the identification information. Additionally, the controller may determine that the interface device has reached a threshold level of degradation based on the associated wash cycle information and generate a notification that the interface device has reached the threshold level of degradation.

In an embodiment, a method may include receiving identification information from an interface device, activating a washer to perform a wash cycle to wash the interface device, associating wash cycle information from the wash cycle with the identification information, and determining a degradation status of the interface device based on the associated wash cycle information and the identification information.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a schematic illustration of a workflow for HMD management that includes a washing system, according to embodiments of the present disclosure;

FIG. 2 is a schematic illustration of a two-part HMD that can be used in the workflow of FIG. 1, according to embodiments of the present disclosure;

FIG. 3 is a block diagram of an example washing system, according to embodiments of the present disclosure;

FIG. 4 is a flowchart of operations of the washing system of FIG. 3, according to embodiments of the present disclosure; and

FIG. 5 is a schematic illustration of an embodiment of the washing system of FIG. 3, according to embodiments of the present disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

The present disclosure relates generally to systems and methods for cleaning/washing portions of an HMD. In the amusement park industry, VR/AR devices have come forth as a promising way of providing a more immersive entertainment experience for guests. Specifically, HMDs with VR/AR capabilities may be linked with specific rides or attractions to generate a VR/AR experience for that ride or attraction. In some cases, HMDs may be made up of two separable portions: a guest interface device and a display. The interface device may be made of a plastic or other washable and reusable material, and may be washable between guest uses. The separate display may be electronic, and, in some cases, may be tethered to a specific ride vehicle or retained with an attraction. In an embodiment, the interface device and display are separated before the interface device is washed to protect the electronic components of the display from fluid exposure. That is, only the interface device is washed in the washing system. The display portion may be cleaned or handled separately.

Provided herein are techniques for interface device washing that monitor and manage properties of the interface devices as they undergo wash cycles. For example, when an individual interface device undergoes a wash cycle, the material or individual components of the interface device may degrade due to the washing conditions of the cycle or repeated use. Accordingly, monitoring the properties of the interface devices may inform employees of the amusement park that a given interface device has reached its shelf-life and should be disposed of or refurbished.

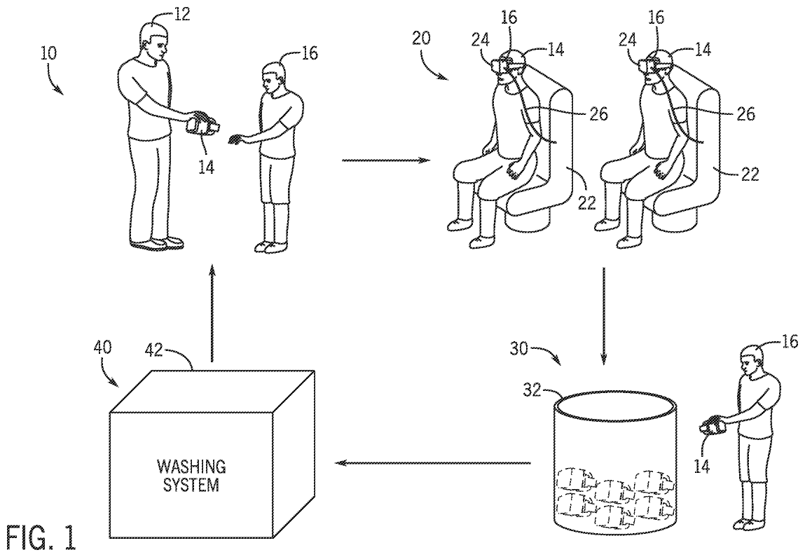

As an introduction, FIG. 1 is a schematic illustration of a workflow for HMD management that includes a washing system as provided herein. The workflow may begin at an HMD distribution 10. In the illustrated example, an employee 12 distributes an HMD or a portion of the HMD, illustrated as an interface device 14, to a guest 16. However, it should be understood that the disclosed embodiments may also be used in conjunction with one-piece or non-separable HMD devices.

When the guest 16 enters into an amusement park, the guest 16 may be issued the interface device 14 by the employee 12. In some embodiments, the timing and location of the HMD distribution may be different. For example, in embodiments where a portion of the amusement park is dedicated to VR/AR experiences, the HMD distribution may take place at an entrance to the VR/AR portion of the amusement park. Alternatively, the HMD distribution may occur when the guest 16 enters into a designated vehicle or other mode of transportation to the amusement park or portion of the amusement park. For example, if a bus or ferry is used to transport guests 16 to the amusement park, the HMD distribution may occur while commuting via the bus or ferry (or other appropriate means) to the amusement park. It should be understood that the examples described are intended to be illustrative only, and there may be other instances where the HMD distribution may occur.

Further, although the employee 12 is shown to hand the interface device 14 to the guest 16, other methods may be used. For example, a mechanical dispenser may dispense the interface devices 14 to the guest 16. The dispenser may be located at a critical entry point of the amusement park, to ensure that the guest 16 has the opportunity to receive the interface device 14. Further, in some embodiments, the interface device 14 may be left at the seat of a VR/AR ride or other location designated for a given guest 16. Accordingly, in some embodiments, the employee 12 may strategically place the interface device 14 so that the guest 16 may receive the interface device 14 before the VR/AR ride begins. In another embodiment, the distribution may include distribution of the entire HMD, and not a separable component.

After receiving the interface device 14, the guest 16 may enter into a ride vehicle 20. In the illustrated example, the guest 16 may sit down in a seat 22. The seat 22 is intended to be illustrative of any station that the guest 16 may be positioned during the course of a ride or amusement park experience. For example, the seat 22 may be a standing location with or without hand rails, a bed or other horizontal laying structure, or other station.

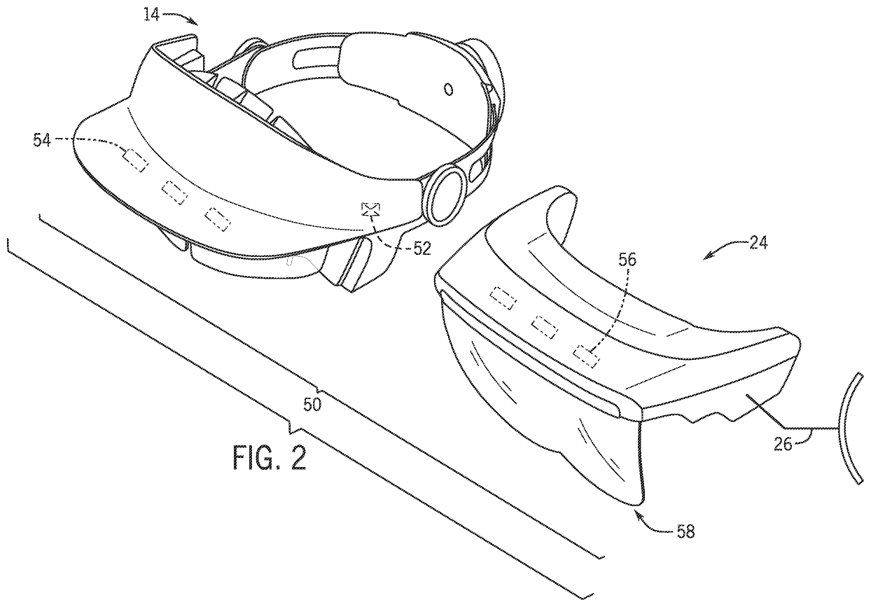

A display 24 component of the HMD may be tethered to the seat 22 via a tether 26. In some embodiments, the display 24 may include a transparent screen to provide the VR/AR experience. The display 24 may be configured to removably couple to the interface device 14 to form a complete HMD (see HMD 50, FIG. 2). For example, when entering the attraction 20, the guest 16 or an operator may attach the display 24 to the interface device 14 in preparation for the VR/AR experience. At the end of the VR/AR experience, the guest 16 or an operator may be prompted to remove the display 24 from the interface device 14. Accordingly, the display 24 may remain tethered to the seat 22 after the guest 16 has detached it from the interface device 14. Thus, the relatively less expensive and more robust interface device 14 can be distributed to guests 16 while they are moving through a queue, because a potential of damage (e.g., dropping, excessive handling) is lower. The more expensive and fragile display portion can be provided to guests while they are seated or moving less freely. However, in this arrangement, guests 16 have greater direct contact with the interface devices 14 as they wait in the queue and move towards the ride vehicle 20, and, therefore, the interface devices 14 may need to be cleaned after each use. Further, as discussed with respect to FIG. 2, the display portion 24 may be all or partly separated from direct guest contact by the interface device 14 while in use. Thus, the display 24 may experience less handling from the guests 16.

In some embodiments, the guest 16 may enter into several attractions during their visit to the amusement park. For example, after exiting a first VR/AR experience, such as a rollercoaster, the guest 16 may go on another VR/AR-enhanced ride or attraction. At the end of their visit to the amusement park, or when the individual attraction is complete, the guest 16 may enter into an unloading area 30 with their user interface device 14, and the guest 16 may deposit the interface device 14 into a container or cart 32. For example, in some embodiments, the cart 32 may be located at an exit of the attraction 20.

At some point (e.g., after the park closes for the day or after the cart 32 is filled to a threshold level), the cart 32 may be transferred to a washing area 40 that includes a washing system 42. For example, in some embodiments, an employee may transport the interface devices 14 together with the container 32 to the washing system 42. Once in the washing area, the interface devices 14 can be loaded individually or in batches into the washing system. Additionally or alternatively, automated systems may transport the interface devices to the washing system 42, as will be discussed herein. Further, the washing system 42 may be configured to track the viability of the interface devices 14 that are washed, and to flag interface devices 14 that have expired their shelf life for removal.

Turning now to FIG. 2, an example HMD 50 is illustrated in a component or separated view that includes the interface device 14 and the display 24. In some embodiments, the interface device 14 may be configured to adjustably fit atop the guest's 16 head. For example, a knob, buckle, cinch, or other reversibly tightening mechanism may be used to fit the interface device 14 onto the head of the guest 16. Further, the interface device 14 may include an identifier 52 to uniquely identify the interface device 14. In some embodiments, the identifier 52 may be an RFID tag or other identifier. In an embodiment, the identifier 52 is positioned on or in the interface device 14. In one embodiment, the identifier 52 is an RFID tag that is embedded in a material of the interface device 14, and the material of the interface device 14 permits radio frequency through transmission.

Of particular importance, the identifier 52 may store data associated with the interface device 14, such as a unique identifier for the interface device 14. Further, in some embodiments, the identifier 52 may also store wash cycle data. Additionally or alternatively, the identifier 52 may be read by a reader to access wash cycle data that is stored on the washing system 42. The wash cycle data may include a variety of data. For example, the wash cycle data may include a counter to indicate how many wash cycles the interface device 14 has undergone. The data may also include information detailing the temperature, water pressure, wash time, chemical usage, and other settings of each wash cycle the interface device 14 has undergone. The wash cycle data may further include any other details of the wash cycles the interface device 14 has undergone to determine the extent of degradation of the interface device 14 due to the wash cycles.

While embodiments of the disclosure are discussed in the context of an RFID tag, it should be understood that other identifiers may be used. For example, the identifier 52 may be a barcode, visible marker, or optical transmitter providing a signal capable of being read by a reader (e.g., an optical sensor or reader).

The interface device 14 may be configured to removably connect to the display 24. For example, the display 24 may connect to a front portion of the interface device 14 to make up the HMD 50. Additionally or alternatively, the display 24 may attach to a side or rear portion of the interface device 14. Further, the display 24 may connect to the interface device 14 via a suitable coupling technique. For example, the interface device 14 may have a snap-on feature that the display 24 may snap onto to secure the connection. Further, Velcro or other adhesive measures may be used to connect the display 24 to the interface device 14. In a particular embodiment, the interface device 14 includes one or more integral magnets 54 that couple to corresponding magnets 56 of the display 24 to attach the interface device 14 and the display 24. The number and relative positions of the magnets 54, 56 are shown by way of example, and it should be understood that other arrangements are also contemplated. When coupled together and in use as the HMD 50, the interface device 14 may at least partially separate the display portion 24 from direct guest contact.

The display 24 may include a screen 58. The screen 58 may be transparent, semi-transparent, or opaque in nature. In an embodiment where the screen is transparent or semi-transparent, the screen 58 may enable the guest to view a real-world environment (e.g., physical structures in the attraction) when activated with certain virtual features (e.g., AR features) overlaid onto the screen 58 so that the guest 16 perceives the virtual features as being integrated into the real-world environment.

In some embodiments, the tether 26 may attach to the display 24 to tether the display 24 to the ride. As illustrated in FIG. 1, the tether may be connected to the seat 22 of the ride. However, the tether 26 may connect to any portion of the ride. For example, in some embodiments, the tether 26 may be tethered to an electronic system of the ride. For example, the tether 26 may include an HDMI or other data conveying connector to supply the AR/VR data from the electronic system to the display 24.

As discussed herein, the disclosed HMDs 50 may be processed by a washing system 42. While the illustrated embodiments are directed to washing of the interface device 14 that is separated from the display 24 in an embodiment of a separable or two-part HMD 50, it should be understood that the disclosed embodiments may also encompass washing an HMD 50, including electronic components, that is implemented in a waterproof or water-resistant housing. As provided herein, the washing system 42 collects identification information from each washed interface device 14 such that the total number of washes and, in embodiments, washing conditions of the interface devices 14 can be tracked. Based upon the tracked information, an individual interface device 14 at the end of its shelf life can be identified.

In an embodiment, a life cycle status of the interface device 14 may be accessed by the display 24 upon coupling of the interface device 14 to the display 24. In one example, the display 24 may directly read the status from the identifier 52. In another example, the display 24 may read the identification information of the interface device 14 from the identifier and communicate with the washing system 42 or another device to access status information of the interface device 14 using the identification information. The status may include an acceptable status or an unacceptable status. The acceptable status may be indicative of the interface device 14 being within its use lifespan (e.g., not having gone through a threshold number of wash cycles) or being above a threshold degradation status. The unacceptable status may be associated with the individual interface device 14 being at the end of its shelf life, e.g. having reached a threshold degradation status. Upon coupling, any interface device 14 for an attraction that has an unacceptable status is flagged for replacement by an operator before the ride is activated.

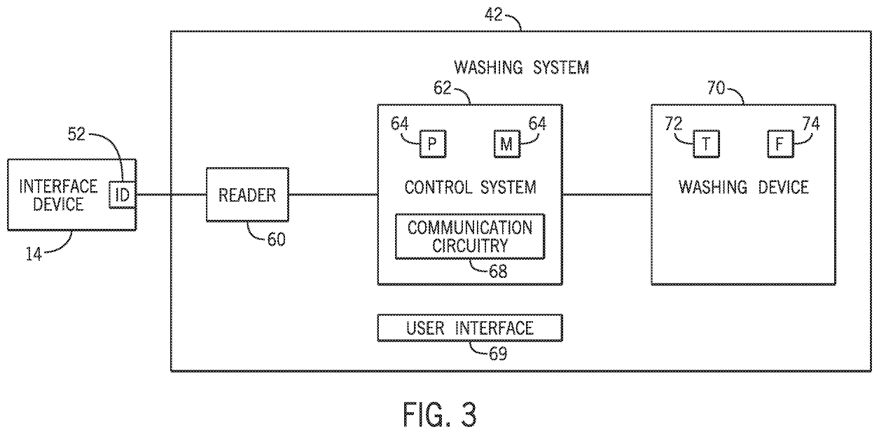

Turning now to a discussion of FIG. 3, the washing system 42 may interact with the data from the identifier 52 of the interface device 14. Accordingly, the washing system 42 may include a reader 60. The reader 60 may acquire data from the identifier 52. For example, in an embodiment where the identifier 52 is an RFID tag, the reader 60 may be an RFID reader configured to read the data stored on the RFID tag. The data may include a unique identifier of the interface device 14. Further, in some embodiments in which data for each interface device 14 is stored locally, the data may include the wash cycle data of the interface device 14. For example, if the interface device 14 has undergone five wash cycles, the data may include the identification of the interface device 14 as well as wash cycle data for each of the five wash cycles that the interface device 14 has undergone.

The reader 60 may transmit the acquired data to a control system 62 of the washing system 42. In some embodiments, the control system may include one or more processors 64 and one or more memory device(s) 66. The one or more processors 64 may execute software programs and/or instructions to track wash information or shelf life information of one or more interface devices 14. Moreover, the processor(s) 64 may include multiple microprocessors, one or more “general-purpose” microprocessors, one or more special-purpose microprocessors, one or more application specific integrated circuits (ASICS), and/or one or more reduced instruction set (RISC) processors. The memory device(s) 66 may include one or more storage devices and may store machine-readable and/or processor-executable instructions (e.g., firmware or software) for the processor(s) 64 to execute. In some embodiments, the processor(s) 64 and the memory device(s) 66 may be external to the control system 62. The memory device(s) 66 may include a tangible, non-transitory, machine-readable-medium, such as a volatile memory (e.g., a random access memory (RAM)) and/or a nonvolatile memory (e.g., a read-only memory (ROM), flash memory, hard drive, and/or any other suitable optical, magnetic, or solid-state storage medium). In an embodiment, the memory device(s) 66 may store a lookup table of the interface device 14 and can organize wash cycle information associated with each interface device 14. For example, the wash cycle information can be stored in a database. The memory device(s) 66 may also store threshold information for designation of an interface device status as expired or permitted to remain in use.

In some embodiments, the control system 62 may be configured to receive the interface device identification data from the reader 60 and the control system 62 may be configured to determine a status of the interface device 14 based on stored data associated with each interface device 14 (e.g., stored identification information) saved in the memory device(s) 66 of the control system 62. For example, if the memory device(s) 66 do not include a profile of the interface device 14 associated with the identification information, then a profile may be created and stored in the memory device(s) 66. This may indicate that the interface device 14 is new and has not deteriorated, as it has not undergone any wash cycles.

If the memory device(s) 66 include a profile of the interface device 14 associated with the identification data, then the status of the interface device 14 may be determined based on data stored in the profile. For example, in some embodiments, the data may include a tracker, such as a counter, to determine how many wash cycles the interface device 14 has undergone. For example, the control system 62 may be configured to determine whether the interface device 14 has undergone a threshold number of wash cycles. Indeed, surpassing the threshold may indicate that the interface device 14 has degraded, over the course of the wash cycles, to the point where it should be discarded. As such, in an embodiment where the tracker indicates that the interface device 14 should be discarded, then the control system 62 may flag the interface device 14 for disposal, as will be discussed herein. In addition, the control system 62 can update the stored data for each interface device 14 by updating the data associated with its unique identifier to include the current or in-progress wash cycle.

In some embodiments, the control system 62 may further include communication circuitry 68. The communication circuitry may include antennas, radio transceiver circuits, signal processing hardware and/or software (e.g., hardware or software filters, A/D converters, multiplexers amplifiers), or a combination thereof, and may be configured to communicate over wireless communication paths via IR wireless communication, satellite communication, broadcast radio, Microwave radio, Bluetooth, Zigbee, etc. Additionally, the communication circuitry 68 may be connected to the internet or other means of communicating with other electronic devices. For example, in some embodiments, the communication circuitry may connect to nearby interface devices 14 via a wireless connection. Further, the communication circuitry 68 may be used to indicate the degradation level of the interface device 14 as determined by the control system 62. For example, in some embodiments, the communication circuitry 68 may instruct the interface device 14 to display its degradation status. For example, the interface device 14 may include an LED, a display, or other indicator that may activate when the interface device 14 has reached a threshold level of degradation. Accordingly, the communication circuitry 68 may send instructions to the interface device 14 to activate the indicator of the interface device 14.

Additionally or alternatively, washing system 42 may provide a notification via a user interface 69 of the washing system 42 that an employee may reference to identify interface devices 14 that are designated to be discarded. Additionally or alternatively, the communication circuitry 68 may send the status indication to a smartphone, laptop, tablet, or other personal electronic device of an employee of the amusement park or other individual/group through which the user interface 69 can be viewed.

In some embodiments, the control system 62 may generate one or more instructions to display the status of the interface device 14 before the interface device 14 has reached the threshold level of degradation. For example, in some embodiments, it may be beneficial to know which interface devices 14 are at, beyond, or close to the threshold degradation level. Accordingly, in some embodiments, the status of the interface devices 14 that are close to the threshold degradation level may be displayed. For example, if the threshold degradation level is 100%, in some embodiments, the status of the interface devices 14 with a degradation of 95% or more may be displayed, as well as those at or beyond the threshold degradation level. In such an embodiment, the interface devices 14 at the threshold degradation level may be indicated differently than those not at the degradation level. For example, the interface devices 14 at the threshold degradation level may be indicated on the operator interface 69 with a highlighted color (e.g., red), while those close to threshold degradation level may be indicated with a different color (e.g., yellow). Further, in some embodiments, interface devices 14 that have surpassed the threshold degradation level may be indicated in yet a different colored light or other indication.

In some embodiments, the status may be listed in text as “expired” when at, beyond or, in some cases, close to the threshold degradation level or “not expired” when not at the threshold degradation level or similar designations to separate interface devices 14 designated for removal versus interface device 14 permitted to reenter distribution to guests. Accordingly, the interface devices 14 at or above the threshold degradation level may be highlighted, bolded, or otherwise visually identified. For example, in some embodiments, the interface devices 14 at or above the threshold degradation level may be spatially separated from other interface devices 14 (e.g., on a separate list, placed at the top of a list, etc.). Further, any other appropriate method for differentiating interface devices 14 at or above the threshold degradation level from the interface devices 14 that are not at the threshold degradation level may be used. Further, it should be noted that the examples described are intended to be illustrative only. Indeed, in some embodiments, the status of most or all of the interface device 14 may be indicated. In an embodiment, only the interface devices 14 that are determined to be at an end of shelf life are indicated via the user interface 69 and/or an indicator on the interface device 14.

The washing system 42 may further include a washing device 70. The washing device 70 may be any device capable of washing interface devices 14. In some embodiments, the washing device 70 may be large enough to wash several interface devices 14 at once. For example, in some embodiments, the interface devices 14 may be grouped together into wash batches, which may include 10, 100, 200, 300, 400, 500, or any other appropriate number of interface devices 14.

A batch of interface devices 14 may enter into the washing device 70 to be washed. For example, in some embodiments, batches of interface devices 14 may be placed into the washing device 70 by an employee, e.g., by loading mesh racks of interface devices 14. In another embodiment, an employee may retrieve the interface devices 14 from the cart 32 and place them into the washing device 70. Additionally or alternatively, an automated system may convey batches of interface devices 14 to the washing device 70. For example, a conveyor belt may be populated with interface devices 14 to be conveyed to the washing device 70 via the conveyor belt. Additionally or alternatively, the automated system may be coupled to the cart 32 to automatically receive and transport the interface devices 14 as they are placed into the container 32. The automated system may be configured to direct the interface devices 14 to the washing device 70. Alternatively, in some embodiments, the automated system may be configured to direct the interface devices 14 to a storage location near the washing device 70. From there, an employee may position the interface devices 14 into the washing device 70.

The washing device 70 may include several sub-components, such as a temperature controller 72 and a fluid controller 74. The temperature controller 72 may include circuitry and sensors to adjust and monitor the temperature of the washing device 70. For example, the temperature controller 72 may adjust the temperature of fluids utilized in a given wash cycle. This may aid in differentiating between wash cycle types. For example, a light wash may operate at a first temperature, and a heavy wash may operate at a second temperature. The first temperature may be cool, warm, room temperature, or other similar temperatures. In some embodiments, the second temperature may be hot, for example, hot enough to cleanse the interface devices 14 more thoroughly than a light wash.

The temperature controller 72 may receive instructions from the communication circuitry 68 or other circuitry within the washing system 42 to determine how to adjust the temperature of a wash cycle. Additionally, the temperature controller 72 may use sensors or other circuitry to monitor the temperature during a wash cycle. Accordingly, the temperature controller may adjust the temperature in a wash cycle based on the monitored temperature and the instructions. In some embodiments, the temperature controller 72 may ensure that the temperature remains constant during a given wash cycle based on the instructions and the monitored temperature. Additionally or alternatively, the temperature controller 72 may adjust the temperature over the course of a given wash cycle. For example, in some embodiments, a wash cycle may run at different temperatures throughout the course of the wash cycle.

The fluid controller 74 may include circuitry and sensors to control and monitor the fluids of a given wash cycle. For example, the fluid controller 74 may monitor the level, pressure, movement, composition, etc. of fluids in the washing device 70. For example, in a given wash cycle, the fluid level, pressure, motions, chemical makeup, and other fluid characteristics may be adjusted over the course of the wash cycle. For example, during a given sequence of a wash cycle a first fluid pressure may be used, which may be increased or decreased during a different sequence of the wash cycle. Further, chemicals such as cleaning products may be added to the fluid at certain points of the wash cycle. The fluid controller 74 may control activation and deactivation of these features. Additionally or alternatively, the fluid controller 74 may adjust the features based on an instruction signal sent from communication circuitry 68 or other circuitry within the washing system 42 that may instruct how the fluids of a given wash cycle may be controlled.

It should be understood that there may be other controllers in the washing device, in addition to or instead of the temperature controller 72 and the fluid controller 74. Further, the washing device 70 may perform any number of washing methods, in addition to those described. Indeed, the washing device 70 may be configured to vary any number of temperature, fluid, and other features to complete a wash cycle. Further, after a wash cycle has been complete, or as part of a wash cycle, the washing device 70 may dry the interface devices 14, either actively (e.g., via fans, ultrasonic vibrations, or other drying methods) or passively (e.g., by waiting a period of time for the interface devices 14 to dry). The interface devices 14 may then be prepared for reuse, for example by being stored in a storage container for an employee to access when handing out interface devices 14, as described in FIG. 1.

Further, the temperature controller 72, the fluid controller 74, and any other controller of the washing device 70 may be configured to submit wash cycle data to the control system 62 to be stored in profiles associated with the interface devices 14 washed in the wash cycle. Accordingly, the profiles of the interface devices 14 and/or the interfaces devices 14 themselves may store all of the wash cycle data associated with each respective interface devices 14. The wash cycle data may then be accessed by the processor(s) 64 of the control system 62 to determine the degradation level of interface devices 14, as previously described.

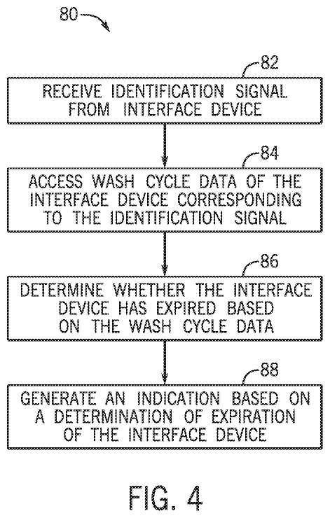

Keeping the forgoing in mind, FIG. 4 illustrates an example method 80 of operations of the washing system 42. In a first step 82, the reader 60 may receive an identification signal from an interface device 14. As discussed previously, this signal may be an RFID signal received by an RFID reader of the reader 60. However, in some embodiments, other methods may be used to receive any type of identification signal.

In a second step 84, the control system 62 may access wash cycle data of the interface device 14 corresponding to the identification signal. For example, the control system 62 may access the identification signal from the reader 60 via the communication circuitry 68 from a stored profile in the memory device(s) 66 or from the interface device 14 data. The identification signal may further include wash cycle data of the corresponding interface device 14. The controller control system 62 may access the wash cycle data from the identification signal via the processor(s) 64 or any other appropriate circuitry of the control system 62.

In a third step 86, the control system 62 may determine whether the interface device 14 has expired based on the wash cycle data. For example, as described previously, the control system 62 may determine a deterioration level of the interface device 14. For example, the control system 62 may determine the deterioration level of the interface device 14 based on the number of wash cycles undergone by the interface device 14, the washing conditions of said previous wash cycles, or both. The control system 62 may then compare the deterioration level of the interface device 14 with a threshold deterioration level. Based on the determination, the status of the individual interface device 14 can be set as being expired and designated to be removed from distribution or not expired and designated to be reentered into guest distribution.

For example, the threshold deterioration level may be pre-determined by empirical assessment and stored in or otherwise accessible to the control system 62. In one example, the assessment may be based on a number or nature of wash cycles associated with a failure of an interface device 14 to successfully magnetically couple to a display 24. The threshold deterioration level may determine when an individual interface device 14 is expired and should be discarded or refurbished. The threshold deterioration level may based on the number of wash cycles undergone by a given interface device 14. For example, if the number of wash cycles is greater than a predetermined number (e.g., 10, 50, 100, 1000), the interface device is determined to be deteriorated. In another embodiment, the determination may based on the cumulative effects of the washing conditions experienced by the interface device 14 on the integrity of the interface device 14. If the deterioration level of the interface device 14 is greater than or equal to the threshold deterioration level, then the control system 62 may determine that the interface device 14 is expired and should be discarded. If the deterioration level of the interface device 14 is less than the threshold deterioration level, however, the control system 62 may determine that the interface device 14 is not expired and may be reused.

In a fourth step 88, the control system 62 may generate an indication of the degradation level of the interface device 14. In some embodiments, the communication circuitry 68 may instruct the interface device 14 to indicate its degradation level using an indicator on or associated with the interface device 14. Additionally or alternatively, the control system 62 may generate a notification via a user interface 69. If the notification is a unique identifier associated with a degraded or past shelf life interface device 14, the method 80 can include receiving a second read of a batch of interface devices 14 to allow the identified interface device 14 to be picked out. For example, when the interface device 14 does not include any on-device degradation indicator, it may be challenging to pick out a degraded interface device 14 from a batch of multiple interface devices 14. When the identified interface device 14 determined to be degraded is read, the system 42 can provide an indication, e.g., via the user interface 69, that the particular interface device 14 should be removed from the batch. The indication can be audible, visual, haptic, or a combination thereof. If the interface device 14 is in a container with multiple interface devices 14, an additional one-by-one read step may be performed.

As discussed, the control system 62 may determine the status of the interface device 14 by considering previous wash cycles. For example, in some embodiments, the data may indicate the washing conditions that the interface device 14 has undergone in previous wash cycles. Accordingly, the control system 62 may determine a degradation level of the interface device 14 based on the data. For example, the control system 62 may determine a percentage of degradation for the interface device 14. For example, if the wash settings (e.g., the temperature, washing time, chemicals used, etc.) of a single wash degrade the interface device 14 by 0.5%, and the interface device 14 has been washed ten times (for example, as indicated by a counter in the data or otherwise determined based on the data), then the control system 62 may determine that the interface device 14 has degraded by 5%. In some embodiments, 100% degradation may indicate that the interface device 14 is no longer viable for use and should be discarded. However, other thresholds may be used to ensure that the interface device 14 does not malfunction during use. For example, the control system 62 may be configured to flag a respective interface device 14 for discarding once it has reached 50%, 60%, 70%, 80%, or 90% degradation, or any other threshold level of degradation.

The level of degradation may be, in an embodiment, an estimation of degradation based on a number of washing cycles completed and/or washing cycle conditions. In one example, the interface device 14 may have a particular point value at the beginning of its life cycle, and undergoing a washing cycle causes the control system 62 to deduct points from the point total. The end of lifespan can be associated with the interface device 14 falling below a particular point total after a sufficient number of points is deducted.

The control system 62 may also determine degradation despite non-uniform washing conditions. For example, in some embodiments, the interface device 14 may undergo irregular wash cycles, as discussed herein. Accordingly, the control system 62 may determine the degradation level of the interface device 14 taking such irregularities into account. For example, if the interface device 14 undergoes a light washing and a heavy washing, each may degrade the interface device 14 by 0.1% and 0.2%, respectively. Accordingly, the control system 62 may determine, based off of the two wash cycles, that the degradation of the interface device 14 is at 0.3%. It should be noted that this example is intended to be non-limiting, and there may be many non-uniform washing conditions that the control system 62 may consider to determine the degradation level of the interface device 14. In some cases, the degradation level is based on a total time of exposure to a particular fluid or a total time at or above a certain temperature level (e.g., above 30° C.) being exceeded. Accordingly, if a total time at a high temperature during a wash cycle is unusually long, the total time is logged, and interface devices 14 from that particular batch may expire more quickly relative to others. Accordingly, based on individual wash cycle conditions, some interface devices 14 may expire at different rates, even if for a same relative number of wash cycles.

The degradation status may, in embodiments, be based on profile data of the interface device 14 that is stored on the control system 62, e.g., stored in the memory device(s) 66. In an embodiment, the degradation status may be stored directly on the interface device 14. Accordingly, the control system 62 may be able to write the data to the tag 52 of the interface device 14.

Further, the degradation status of the interface device 14 may be determined at any time. For example, the status may be determined before the interface device 14 undergoes a given wash cycle. Accordingly, the interface device 14 may be flagged to be removed either before or after a wash cycle. Additionally or alternatively, the interface device 14 degradation status may be determined after a given wash cycle. In such an embodiment, the interface device 14 may be flagged for prompt removal so that the interface device 14 does not remain in operation.

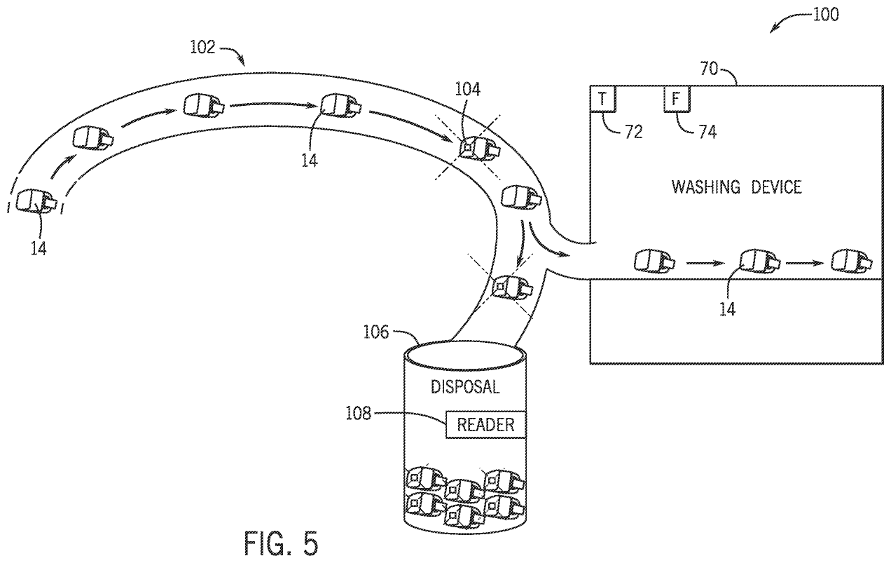

In some embodiments, automatic systems may convey the interface devices 14 to and from the washing device 70. Accordingly, FIG. 5 illustrates an example embodiment of an automation system 100. The system 100 may include a transport device 102. In some embodiments, the transport device 102 may be a conveyor belt, a trolley, or any other automatically moving mechanism. The interface devices 14 may be placed on the transport device 102, for example, by an employee or other conveying system. The interface devices 14 may then be transferred via the transport device 102 toward the washing device 70.

As previously discussed, in some embodiments, the washing system 42 may instruct a given interface device 14 to indicate whether it has degradation to or beyond a threshold degradation level. Accordingly, in some embodiments, the interface devices 14 may include an LED light 104. The light 104 may be configured to turn on if the interface device 14 has met the threshold level of degradation to indicate that the interface device 14 is expired and should be disposed. Further, as mentioned previously, there may be other ways to indicate that the interface device 14 has expired.

As illustrated, if the interface device 14 is expired, it will enter into a disposal container 106. From there, the expired interface devices 14 may be disposed of, either by an employee or other automated system. Further, the disposal container 106 may include a reader 108 to track the interface devices 14 entering into the disposal container 106. For example, the reader 108 may be an RFID reader. The reader 108 may be utilized to ensure that the interface devices 14 that are expired are properly transferred to the disposal container 106. For instance, in some embodiments, the washing system 42 may include circuitry to communicate with the reader 108 to track the disposal of expired interface devices 14. In some embodiments, the communication circuitry 68 may receive signals from the reader 108 and may transfer the signals to other circuitry of the control system 62 to track the disposal of the expired interface devices 14.

Alternatively, the interface devices 14 that are not expired may enter into the washing device 70 and be washed accordingly. Further, in some embodiments, the disposal container and reader 108 may be located beyond the washing device 70. For example, instead of determining the degradation level prior to washing, in some embodiments, the control system 62 may determine the degradation level after each wash cycle. For example, if a given wash cycle results in one of the interface devices 14 meeting or exceeding the degradation threshold level, that interface device 14 may be transferred to the disposal container 106.

While only certain features have been illustrated and described herein, many modifications and changes will occur to those skilled in the art. It is, therefore, to be understood that the appended claims are intended to cover all such modifications and changes as fall within the true spirit of the disclosed embodiments.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for (perform)ing (a function) . . . ” or “step for (perform)ing (a function) . . . ”, it is intended that such elements are to be interpreted under 35 U.S.C. 112(f). However, for any claims containing elements designated in any other manner, it is intended that such elements are not to be interpreted under 35 U.S.C. 112(f).

1. A head-mounted device washing system comprising:
a reader configured to read identification information from an interface device of a plurality of interface devices, wherein the interface device of the plurality of interface devices comprises a radio frequency identification (RFID) tag storing the identification information of the interface device;
a washing system; and
a controller comprising a processor and a memory, wherein the controller is configured to:
receive the identification information from the reader;
receive wash cycle information of the interface device from the washing system; and
determine whether the interface device has reached a threshold level of degradation based on the identification information or the wash cycle information.

2. The system of claim 1, wherein the controller is configured to identify the interface device based on the identification information and estimate a current level of degradation of the interface device based on the wash cycle information.

3. The system of claim 2, wherein the controller is configured to determine that the interface device has reached the threshold level of degradation by comparing the estimated level of degradation of the interface device with the threshold level of degradation.

4. The system of claim 1, wherein the wash cycle information is indicative of washing conditions experienced by the interface device via the washing system.

5. The system of claim 1, wherein the washing system is configured to wash the plurality of interface devices with variable temperature and fluid settings.

6. The system of claim 5, wherein the wash cycle information comprises temperature and fluid settings associated with past wash cycles of the interface device.

7. The system of claim 1, wherein the controller is configured to store a respective profile associated with a respective one of the plurality of interface devices.

8. The system of claim 7, wherein the respective profile comprises respective identification information of the respective one of the plurality of interface devices.

9. The system of claim 7, wherein the respective profile comprises wash cycle information indicative of washing conditions experienced by the respective one of the plurality of interface devices via the washing system.

10. The system of claim 1, wherein the interface device is configured to reversibly mate with a display to form a head-mounted device.

11. A head-mounted device washing system comprising:
an interface device configured to reversibly mate with a display, the interface device comprising a radio frequency identification (RFID) tag associated with the interface device, the RFID tag storing identification information of the interface device;
a reader configured to read the identification information from the RFID tag;
a washing system; and
a controller comprising a processor and a memory, wherein the controller is configured to:
receive the identification information from the reader;
receive wash cycle information from the washing system;
associate the wash cycle information with the identification information;
determine that the interface device has reached a threshold level of degradation based on the associated wash cycle information; and
generate a notification that the interface device has reached the threshold level of degradation.

12. The system of claim 11, wherein the controller is configured to determine that the interface device has reached the threshold level of degradation based on a count of wash cycles of the interface device being above a predetermined threshold.

13. The system of claim 11, wherein the interface device is configured to be unmated from the display prior to being washed by the washing system.

14. The system of claim 11, wherein the controller is configured to store a profile of the interface device in the memory, wherein the profile comprises the identification information and the associated wash cycle information.

15. The system of claim 14, wherein the wash cycle information is indicative of washing conditions experienced by the interface device via the washing system.

16. The system of claim 11, wherein the controller is configured to generate instructions to activate an indicator on the interface device in response to the interface device reaching the threshold level of degradation.

17. A head-mounted device washing method, comprising:
receiving, using a reader, identification information from an interface device;
activating a washer of a washing device to perform a wash cycle to wash the interface device;
associating, using a control system, wash cycle information from the wash cycle with the identification information; and
determining, using the control system, a degradation status of the interface device based on the associated wash cycle information and the identification information.

18. The method of claim 17, wherein determining the degradation status comprises determining that washing conditions of the wash cycle in conjunction with previous washing conditions have cumulatively caused the interface device to degrade.

19. The method of claim 17, further comprising indicating, via a controller, that the interface device has expired based on the degradation status and flagging the interface device for replacement.

20. The method of claim 19, wherein the degradation status is associated with the expired interface device based on a total count of the wash cycle and previous wash cycles of the interface device being above a predetermined threshold.
